(19) United States
(12) Patent Application Publication
(10) Pub. No.: US 2016/0054960 A1
(43) Pub. Date: Feb. 25, 2016

(54) SYSTEM, IMAGE PROCESSING APPARATUS, SERVER AND METHOD OF CONTROLLING THEREOF

(71) Applicant: CANON KABUSHIKI KAISHA, Tokyo (JP)

(72) Inventor: Keisuke Ito, Tokyo (JP)

(21) Appl. No.: 14/817,438

(22) Filed: Aug. 4, 2015

(30) Foreign Application Priority Data
Aug. 19, 2014 (JP) 2014-167000

(51) Int. Cl. G06F 3/12

(52) U.S. Cl. CPC G06F 3/1231; G06F 3/1205

(57) ABSTRACT

The present invention includes an image processing apparatus provided with a storage unit storing a setting value for defining operation content of the image processing apparatus and specification management information relating to a specification of the setting value; when the stored setting value is changed, information relating to the change to the setting value is communicated to a server configured to manage master data for the setting value, and when information concerning a change to the master data of the server is received, stored setting information is changed, and the specification management information is transmitted to the server.

### BACKGROUND OF THE INVENTION

1. Field of the Invention

The present invention relates to a system, an image processing apparatus, a server and a method of controlling thereof.

2. Description of the Related Art

In recent years, a setting value management system has been developed to save in a network connected server or the like and manage in a unified fashion setting values for a multifunction peripheral or the like. Each setting value is synchronized, and when the setting value on the server is changed, the changed value is communicated to the multifunction peripheral, and the setting value in the multifunction peripheral is changed. Similarly, when the setting value in the multifunction peripheral is changed, the setting value on the server is changed. Depending on the setting value, there exist those for which the value is synchronized between a plurality of multifunction peripherals, and when the setting value for one multifunction peripheral is changed, the setting value on the server and the setting value for all the multifunction peripherals that are synchronization targets are changed. Japanese Patent Laid-Open No. 2013-1044 proposes a setting value management system for managing configuration data for a plurality of image forming apparatuses, and also using an appropriate setting method to set the configuration data from amongst a plurality of setting methods.

In such a setting value management system, in addition to a setting value DB that holds value information for each setting value, specification information for each setting value, such as an initial value, a value range, a suitable model/version, or a display condition for the setting value, is held on the server. When accepting a setting value change on the server, only a change that satisfies this specification information is permitted. For example, a change or the like to a value outside the value range is not permitted. In addition, it is typical to store in advance specification information for every model and every firmware version on the server.

However, there is a problem with the above described conventional technique as recited below. For example, for the above described setting value management system, a configuration of preparing a dedicated server or a configuration of using a multifunction peripheral itself as the server can be considered. In the latter case, a plurality of multifunction peripherals are connected to a network, and one of these is caused to have the server function. By configuring in this fashion, there is no need to set up a separate dedicated the server, and introduction of the setting value management system becomes easier. However, with a multifunction peripheral for which a storage capacity is limited, it is difficult to hold specification information for every models and every firmware version, and usage as a server for the setting value management system is not realistic. Note that even with a dedicated server the storage capacity is limited, and it is possible for the above-described problem to occur.

### SUMMARY OF THE INVENTION

The present invention enables realization of an applicable arrangement for an apparatus having a server function, even in the case where only appropriate information is selectively managed and a storage capacity of the apparatus is limited.

One aspect of the present invention provides a system comprising an image processing apparatus and a server managing the image processing apparatus, wherein the image processing apparatus comprises: a storage unit configured to store a setting value for defining operation content of the image processing apparatus; and a transmission unit configured to transmit to the server specification management information that includes information that indicates a range for a value that can be set in the setting value; and the server comprises: a management unit configured to manage master data for the setting value; a reception unit configured to receive the specification management information transmitted by the transmission unit; a change unit configured to change the master data managed by the management unit based on the specification management information received by the reception unit; and a first notification unit configured to communicate to the image processing apparatus information relating to a change to the master data by the change unit, wherein the image processing apparatus is configured to update the setting value stored by the storage unit based on the information communicated by the first notification unit.

Another aspect of the present invention provides an image processing apparatus, comprising: a storage unit configured to store a setting value for defining operation content of the image processing apparatus; a transmission unit configured to transmit specification management information that comprises information that indicates a range for a value that can be set in the setting value to a server that manages master data for the setting value; a reception unit configured to receive information related to a change to the master data, which is communicated from the server in accordance with a change to the master data based on the specification management information transmitted by the transmission unit; and an updating unit configured to update the setting value stored by the storage unit based on the information received by the reception unit.

Still another aspect of the present invention provides a server configured to manage an image processing apparatus, comprising: a management unit configured to manage master data for a setting value for defining operation content of the image processing apparatus; a reception unit configured to receive specification management information, transmitted from the image processing apparatus, comprising information indicating a range for a value that can be set in the setting value; a change unit configured to change the master data managed by the management unit based on the specification management information received by the reception unit; and a notification unit configured to communicate to the image processing apparatus information relating to a change to the master data by the change unit.

Yet still another aspect of the present invention provides a method of a system comprising an image processing apparatus and a server managing the image processing apparatus, the method comprising: the image processing apparatus storing a setting value for defining operation content of the image processing apparatus in a storage unit; and transmitting to the server specification management information that comprises information that indicates a range for a value that can be set in the setting value, and the server managing master data for the setting value; receiving the transmitted specification management information; changing the managed master data based on the received specification management information; and first communicating to the image processing apparatus information relating to a change to the master data in the change step, wherein the image processing apparatus is configured to update the setting value stored in the storage unit based on the information first communicated.

Still yet another aspect of the present invention provides a method of controlling an image processing apparatus, the method comprising: storing a setting value for defining operation content of the image processing apparatus in a storage unit; and transmitting specification management information that comprises information that indicates a range for a value that can be set in the setting value to a server that manages master data for the setting value; receiving information related to a change to the master data, which is communicated from the server in accordance with a change to the master data based on the transmitted specification management information; and updating the setting value stored in the storage unit based on the received information.

Yet still another aspect of the present invention provides a method of a server configured to manage an image processing apparatus, the method comprising: managing master data for a setting value for defining operation content of the image processing apparatus; receiving specification management information, transmitted from the image processing apparatus, comprising information indicating a range for a value that can be set in the setting value; changing the managed master data based on the received specification management information; and communicating to the image processing apparatus information relating to the changing of the master data.

Further features of the present invention will be apparent from the following description of exemplary embodiments with reference to the attached drawings.

### BRIEF DESCRIPTION OF THE DRAWINGS

FIG. 1 is a system configuration diagram illustrating a setting value synchronization system as a whole.

FIG. 2 is a block diagram representing a configuration of a setting value management server 110.

FIG. 3 is a block diagram representing a configuration of multifunction peripherals 120a,b.

FIG. 4A is a view representing a configuration of master data managed by the setting value management server 110 according to a first embodiment.

FIG. 4B is a view representing a configuration of master data managed by the setting value management server 110 according to a first embodiment.

FIG. 5 is a view representing a configuration of a setting value DB 501 stored in an HDD of a multifunction peripheral.

FIG. 6 is a flowchart representing processing executed when a setting value change request is accepted by the setting value management server 110 according to the first embodiment.

FIG. 7 is a view for showing an example of a setting value change screen displayed on a display unit 230 according to the first embodiment.

FIG. 8 is a flowchart representing processing executed when the multifunction peripherals 120a,b according to a first embodiment reflect a change to a setting value. are changing

FIG. 9 is a flowchart representing processing executed when the multifunction peripherals 120a,b according to the first embodiment connect to the setting value management server 110 for the first time.

FIG. 10 is a flowchart representing processing executed when the multifunction peripherals 120a,b according to a second embodiment connect to the setting value management server 110 for the first time.

FIG. 11 is a flowchart representing processing executed when a firmware update or a version downgrade occurs in the multifunction peripherals 120a,b according to a third embodiment.

FIG. 12 is a flowchart representing processing executed when the multifunction peripherals 120a,b according to a fourth embodiment are removed from a management target for the setting value management server 110.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### System Configuration

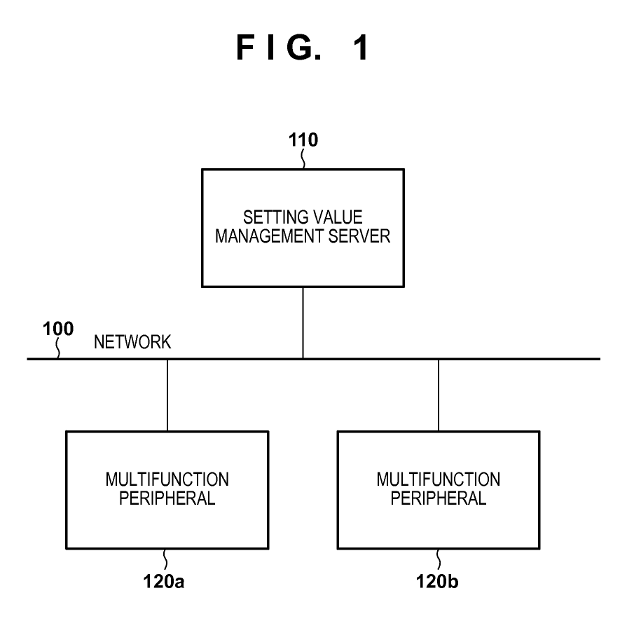

Below, explanation will be given for the first embodiment of the present invention with reference to FIG. 1 through FIG. 9. Firstly, with reference to FIG. 1, explanation will be given of a system configuration indicating an overall setting value synchronization system in the present invention. Connected to a network 100 is a setting value management server 110, and a plurality of multifunction peripherals 120a, 120b.

The setting value management server 110 manages in consolidation master data for setting values for the plurality of multifunction peripherals 120a,b—each being an example of an image processing apparatus. According to the present embodiment, the setting value management server 110 may be arranged as a dedicated server, or may be arranged as an image processing apparatus. Here, a setting value is for defining operation content of the image processing apparatus, for example, a density correction for a color material, a toner amount correction for a time of printing, an auto-sleep transition time, a display of a job history, or the like. When there is a change to the master data, change information is communicated to the multifunction peripheral 120a and the multifunction peripheral 120b via the network 100. When change information for a setting value is received from the multifunction peripheral 120a or the multifunction peripheral 120b, the value of ones own master data is changed.

Each of the multifunction peripherals 120a, 120b is a device that provides a plurality of functions (copying, FAX, or the like), and stores internally a setting value used at the time of execution of each of the functions. If there is a change to the setting value, change information is communicated to the setting value management server 110 via the network 100. When change information for the master data of the setting value is received from the setting value management server 110, ones own setting value is changed. Note that in accordance with the setting value, there is a case of performing synchronization control of a value between a plurality of multifunction peripherals, such as between the multifunction peripheral 120a and the multifunction peripheral 120b.

Regarding the setting value for each multifunction peripheral, if there a change to the master data on the setting value management server 110, change information for the setting value is communicated to both the multifunction peripheral 120a and the multifunction peripheral 120b. Configuration may be taken such that when there is a change to a setting value for either of the multifunction peripheral 120a or the multifunction peripheral 120b, firstly change information is communicated to the setting value management server 110, and thereafter, the change information is communicated to the other multifunction peripheral via the setting value management server 110. A detailed configuration for the setting value management server 110, and the multifunction peripherals 120a, 120b is described later.

<Configuration of the Setting Value Management Server>

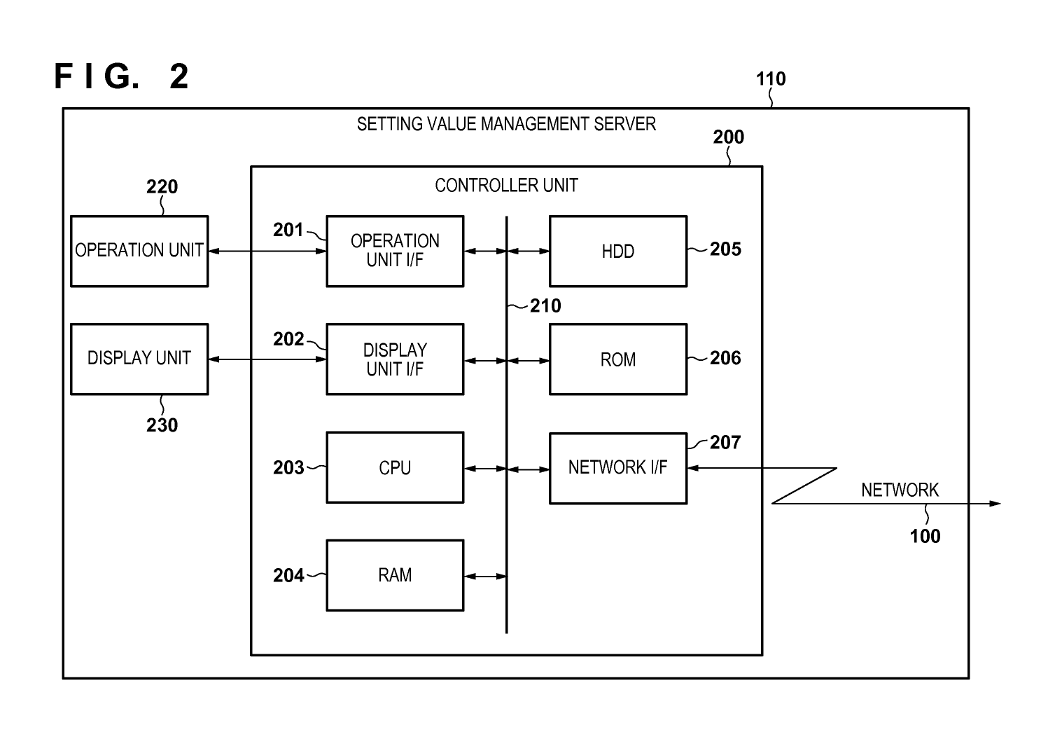

Next, referring to FIG. 2. explanation will be given for configuration of the setting value management server 110 according to the present embodiment. The setting value management server 110 is provided with a controller unit 200, an operation unit 220, and a display unit 230. The controller unit 200 is provided with a CPU 203, an operation unit I/F 201, a display unit I/F 202, a RAM 204, an HDD 205, a ROM 206, and a network I/F 207.

The CPU 203 (Central Processing Unit) activates an OS (Operating System) through a boot program stored in the ROM (Read Only Memory) 206. The CPU 203, through the OS, executes application programs stored in the HDD (Hard Disk Drive) 205, and thereby executes various processing. The RAM (Random Access Memory) 204 is used as a work area for the CPU 203.

The HDD 205 stores the above-described the application programs, master data for a setting value for the multifunction peripherals 120a, 120b included in the network 100, or the like. Detail regarding a management approach for the master data is described later. Furthermore, as well as the ROM 206 and the RAM 204, the operation unit I/F 201, the display unit I/F 202, and the network I/F 207 are connected to the CPU 203 via a system bus 210. The operation unit I/F 201 is an interface for the operation unit 220 comprising a mouse, keyboard, or the like, and sends information, input by a user through the operation unit 220, to the CPU 203. The display unit I/F 202 outputs image data to be displayed on the display unit 230, which comprises a display or the like, to the display unit 230. The network I/F 207 is connected to the network 100, and performs input and output of information with each apparatus on the network 100 via the network 100.

<Multifunction Peripheral Configuration>

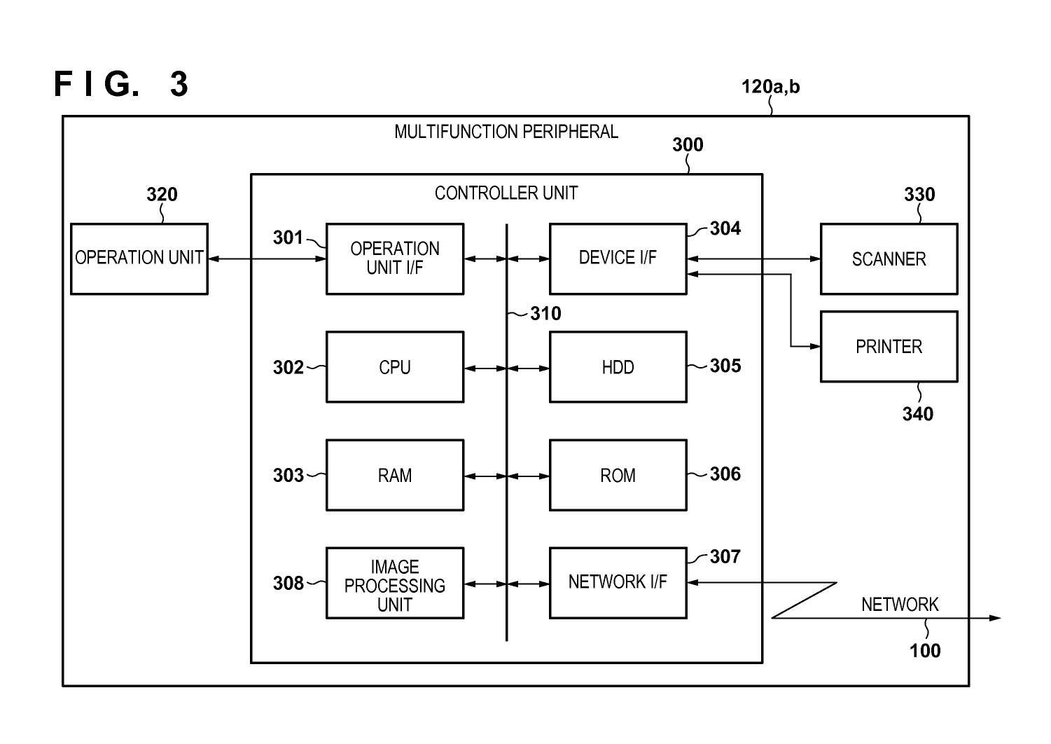

Next, referring to FIG. 3, explanation is given for configuration of the multifunction peripherals 120a,b, each of which is an image processing apparatus according to the present embodiment. Each of the multifunction peripherals 120a,b is provided with a controller unit 300, an operation unit 320, a scanner 330, and a printer 340. The controller unit 300 is connected to the operation unit 320, and is also connected to the scanner 330, which is an image input device, and the printer 340, which is an image output device. The controller unit 300 is also provided with an operation unit I/F 301, a CPU 302, a RAM 303, a device I/F 304, an HDD 305, a ROM 306, a network I/F 307, and an image processing unit 308.

The CPU (Central Processing Unit) 302 activates an OS (Operating System) through a boot program stored in the ROM (Read Only Memory) 306. The CPU 302, through the OS, executes application programs stored in the HDD (Hard Disk Drive) 305, and thereby executes various processing. The RAM (Random Access Memory) 303 is used as a work area for the CPU 302. The RAM 303 provides a work area and also provides an image memory region for temporarily storing image data. The HDD 305 stores the above-described the application programs, the image data, and various settings values. A setting value management approach in the multifunction peripherals 120a,b is described later.

The CPU 302 is connected to the ROM 306 and the RAM 303 via a system bus 310, and is also connected to the operation unit I/F 301, the device I/F 304, the network I/F 307, and the image processing unit 308. The operation unit I/F 301 is an interface for the operation unit 320, which has a touch panel, and outputs image data to be displayed on the operation unit 320 to the operation unit 320. The operation unit I/F 301 sends information input by the user through the operation unit 320 to the CPU 302. Connected to the device I/F 304 are the scanner 330 and the printer 340, and the device I/F 304 performs conversion between a synchronous system and an asynchronous system for the image data. The network I/F 307 is connected to the network 100, and performs input and output of information with each apparatus on the network 100 via the network 100. The image processing unit 308 performs processing such as processing of images input from the scanner 330, processing of images output to the printer 340, image rotation, image compression, resolution conversion, color space conversion, gray-level transformation, or the like.

<Master Data>

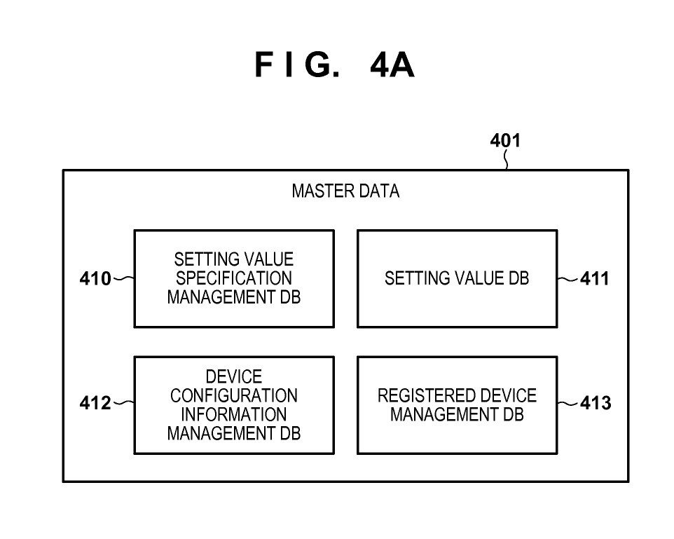

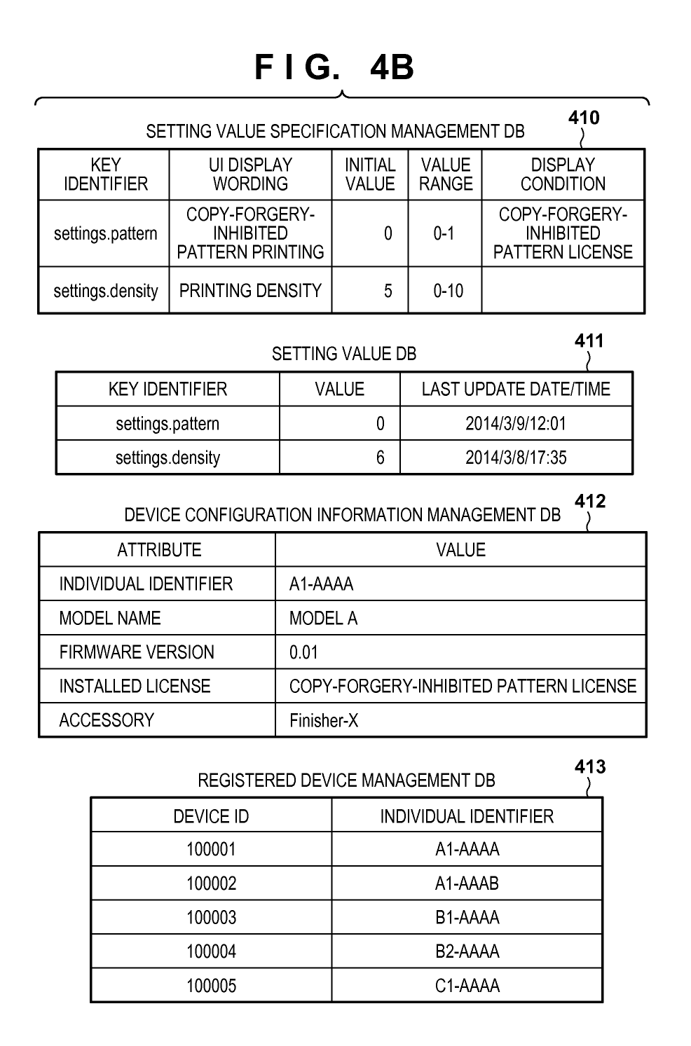

Next, referring to FIG. 4A and FIG. 4B, explanation will be given for an example configuration of master data managed by the setting value management server 110 in the present embodiment. As shown in FIG. 4A, master data 401 is comprised from a setting value specification management DB 410, a setting value DB 411, a device configuration information management DB 412, and a registered device management DB 413. FIG. 4B shows content for each DB (database).

The setting value specification management DB 410 is a database storing metadata (specification management information) regarding each setting value managed by the setting value management server 110. More specifically, the setting value specification management DB 410 stores wording (display content) for when presentation is made to a user, a key identifier for identifying a setting value when performing communication with the multifunction peripherals 120a,b, an initial value, a value range, and a display condition for the setting value. Here the value range indicates a settable value range for a corresponding key identifier. The display condition is a condition to display a corresponding setting value on a setting value change screen that is explained later. Each setting value managed through the setting value specification management DB 410 depends on a model or a firmware version of a multifunction peripheral, and may differ in setting value range, initial value, whether the setting value exists, or the like. In a configuration of preparing a dedicated server as the setting value management server 110, the setting value specification management DB 410 is held in advance in the setting value management server 110. In contrast, a configuration in which an image processing apparatus for which a storage capacity is not very large, such as the multifunction peripherals 120a,b, is used as the server, is also considered. In such a case, when the multifunction peripherals 120a,b are initially connected to the setting value management server 110, that is when first accessed, the setting value specification management DB 410 is sent from the multifunction peripherals 120a,b, but a memory capacity to handle the same information amount as in the case where a dedicated server is used is insufficient. According to this embodiment, it is possible to avoid a deficiency of memory capacity even in a case of providing the server function in an image processing apparatus, through controlling that is described later.

The setting value DB 411 is a database that manages setting value information. The setting value DB 411 stores a key identifier, a value corresponding to the key identifier, and a last update date and time for the setting value. The key identifier is an identifier having the same system as the key identifier for the setting value specification management DB 410. For example, in the example of FIG. 4B, for the key identifier “settings.density”, a value “6” and a value for a last update date and time “2014/3/8/17:35” are registered.

The device configuration information management DB 412 is a database that manages content of device configuration information for each individual multifunction peripheral. The device configuration information includes as attributes, a device identifier that identifies an individual one of the multifunction peripherals 120a,b, a model name, a firmware version, license information representing a useable function, an accessory, or the like. Note that the model name, the firmware version, the license or the like have the same system as those stored in the setting value specification management DB 410. As indicated in FIG. 4B, the value of each attribute is able to be represented by a character string or a numerical value.

The registered device management DB 413 is a database for managing content of device identifier information for the multifunction peripherals 120a,b that manages setting values through the setting value management server 110. The registered device management DB 413 stores a device ID for uniquely identifying the multifunction peripherals 120a,b that are to be synchronized, a device identifier for identifying an individual one of the multifunction peripherals 120a,b, or the like. For example, in the example of FIG. 4B, a device ID “100001” and a device identifier “A1-AAAA” are defined in association.

The setting value management server 110 is able to manage in one batch the setting values and metadata for each setting value itself by using each database of the master data 401 explained above.

<Device Setting Value DB>

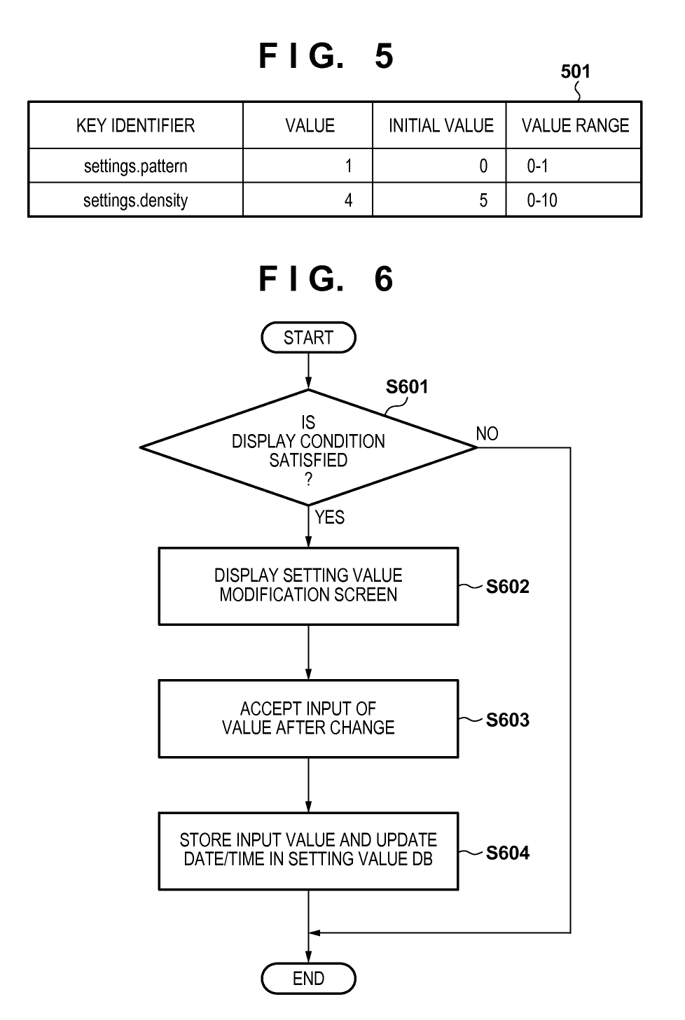

Next, referring to FIG. 5, explanation is given for an example configuration of a device setting value DB 501 stored on the HDD 305 of the multifunction peripherals 120a,b, which are the client side in the present embodiment. The device setting value DB 501 is a database storing a setting value used by the multifunction peripherals 120a,b.

The setting value stored in the device setting value DB 501 is configured from elements such as a key identifier for identifying the setting value, a setting value, an initial value, a value range, or the like. These elements are managed with the same system as those managed in the master data 401. If the setting value is changed in the setting value management server 110 or the multifunction peripherals 120a,b, synchronization control of the setting value is performed by communicating at least the key identifier and the value of data shown in FIG. 5. In addition to the setting value DB 501, the HDD 305 also stores the setting value specification management DB 410, and stores setting value specification information for the version and model of the multifunction peripherals 120a,b themselves.

<Setting Value Change Procedure>

Next, referring to FIG. 6 and FIG. 8, explanation is given for a series of procedures performed when the setting value is changed on the setting value management server 110, in which the change is communicated to the multifunction peripherals 120a,b, and synchronization control for the setting value is performed. During this, the setting value specification management DB 410 on the setting value management server 110 is used during processing. Firstly, using FIG. 6, an explanation is given for a processing procedure when accepting a display request from the setting value change screen on the setting value management server 110 to explain a case in which the setting value specification management DB 410 is used. Here, explanation is given of an example of a case in which each DB shown in FIG. 4B exists on the server, and a request to display a setting value change screen for the setting value “printing density (settings.density)” is accepted. This flowchart is something for which the CPU 203 of the setting value management server 110 reads a program from the HDD 205, loads the program into the RAM 204, and executes the program.

In step S601, the CPU 203 refers to the setting value specification management DB 410 and the device configuration information management DB 412, and then determines whether the setting value for which the request to display the setting value change screen has been accepted satisfies the display condition. When the display condition is satisfied, processing advances to step S602, and when not satisfied, processing terminates. For example, installation of a copy-forgery-inhibited pattern license is a display condition for a setting value “copy-forgery-inhibited pattern printing”, and if already installed the processing proceeds to step S602.

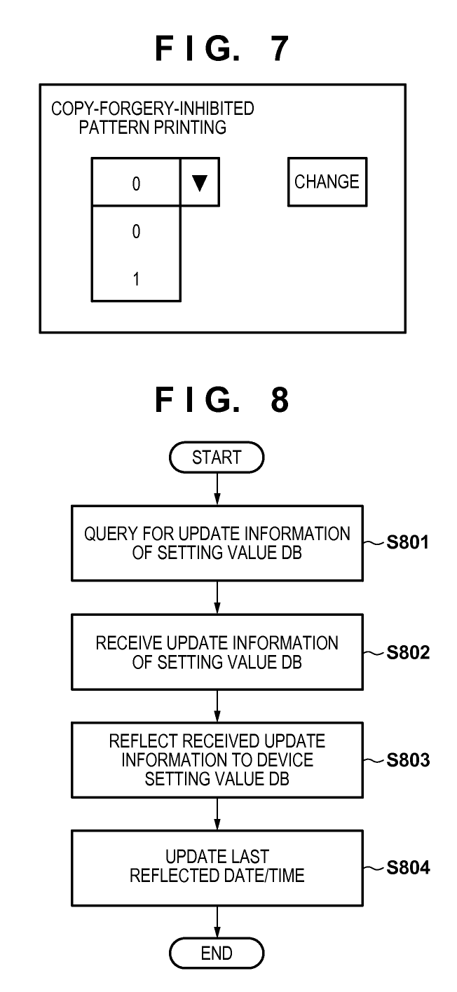

In step S602, the CPU 203 displays the setting value change screen as in FIG. 7 to the display unit 230. At this point, the option of the value displayed on a pull-down after it is changed is determined based on value range information held in the setting value specification management DB 410. The value range for the setting value “copy-forgery-inhibited pattern printing” is 0 to 1, so options (“0”, “1”) are displayed as shown in FIG. 7.

In step S603, the CPU 203 accepts input of the changed value through the operation unit 220. Subsequently, in step S604 the CPU 203 stores the value input in step S603 and an update date/time in the setting value DB 411, and processing terminates.

Next, referring to FIG. 8, explanation is given for a processing procedure in which the multifunction peripherals 120a,b poll the setting value management server 110, detect the change of the setting value DB 411, and reflect the change to the setting value DB 501. This flowchart is something for which the CPU 302 of the multifunction peripherals 120a,b reads a program from the HDD 305, loads the program into the RAM 303, and then executes the program. Note that the multifunction peripherals 120a,b periodically perform the processing explained below at regular intervals.

In step S801, the CPU 302 queries the setting value management server 110 for update information of the setting value DB 411. At this point, a request is transmitted along with a last reflected date/time at which the multifunction peripherals 120a,b last reflected a change of the setting value DB 411 to the device setting value DB 501. The last reflected date/time is stored in the HDD 305.

In step S802, the CPU 302 receives changed values, transmitted from the setting value management server 110, for all setting values for which there were updates in the setting value DB 411 after the last reflected date/time queried in step S801. Subsequently, in step S803 the CPU 302 reflects, the changed value for each setting value received in step S802, in the device setting value DB 501. In step S804, the CPU 302 updates the last reflected date/time stored in the HDD 305.

With a flow as above, when a setting value on the setting value management server 110 is changed, the change is communicated to the multifunction peripherals 120a,b, and synchronization control is performed for the setting value. The setting value specification management DB 410 is used during processing on the setting value management server 110. At this point, when the storage capacity of the setting value management server 110 is not very large, it is difficult to hold the setting value specification management DB 410 in which specification information for all models and all firmware versions is included. Here, when the multifunction peripherals 120a,b first connect to the setting value management server 110, if configuration is taken so that the setting value specification management DB 410 which records specification information for only ones own model and version, which are held by of each of the multifunction peripherals 120a,b, is sent, server side management of extra information is not required. Thereby, usage as the setting value management server 110 is possible even with a server for which storage capacity is not very large.

<Control at Time of Initial Connection>

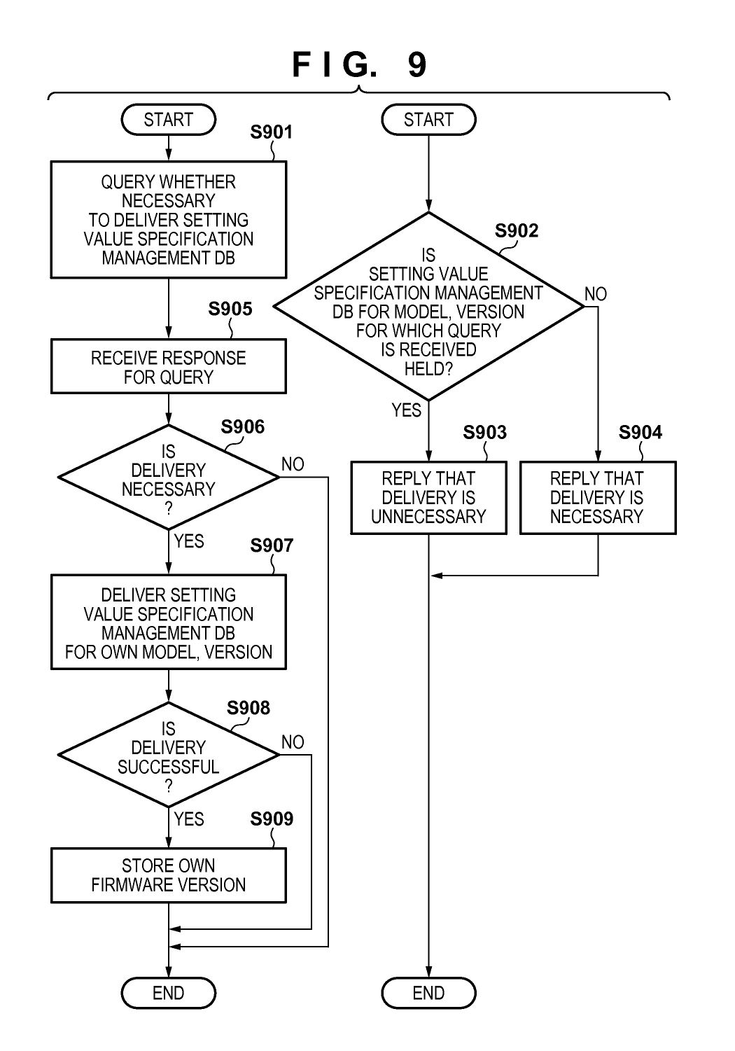

Next, referring to FIG. 9, explanation is given for a processing procedure for when sending the setting value specification management DB 410 when the multifunction peripherals 120a,b make an initial connection to the setting value management server 110. This flowchart is executed by the CPU 203 of the setting value management server 110 and the CPU 302 of the multifunction peripherals 120a,b reading programs from the HDD 205 and the HDD 305, loading the programs into the RAM 204 and the RAM 303, and then executing the programs. Note that step S901, step S905 or later is processing in the multifunction peripherals 120a,b, and step S902 to step S904 is processing in the setting value management server 110.

In step S901, the CPU 302 of the multifunction peripherals 120a,b communicates the model name and firmware version (information for identifying a multifunction peripheral) to the setting value management server 110 for which the initial connection is performed, and queries as to whether there is a need to send the setting value specification management DB 410. In step S902, the CPU 203 of the setting value management server 110 determines whether the setting value specification management DB 410 corresponding to the model name and the firmware version communicated in step S901 is held in the HDD 205. If held, the processing proceeds to step S903, if not held, the processing proceeds to step S904.

In step S903, the CPU 203 responds that sending of the setting value specification management DB to the multifunction peripherals 120a,b is not necessary based on the result of the determination of step S902, and processing terminates. Meanwhile, in step S904, the CPU 203 responds that sending of the setting value specification management DB to the multifunction peripherals 120a,b is necessary based on the result of the determination of step S902, and processing terminates.

In step S905 the CPU 302 receives the response to the query in step S901, communicated from the multifunction peripherals 120a,b. Subsequently, in step S906 the CPU 302 determines whether the response received in step S905 indicates whether it is necessary to send the setting value specification management DB 410. If there is necessity to send it, the processing proceeds to step S907; when that is not the case processing terminates.

In step S907, the CPU 302 sends the setting value specification management DB 410 for the model and version of the peripheral device itself, which are stored in the HDD 305, to the setting value management server 110. At this point, the model name and the firmware version are communicated together. Subsequently, in step S908 the CPU 302 determines whether sending of the setting value specification management DB 410 in step S907 succeeded. If it succeeded, the processing proceeds to step S909; if it failed, the processing terminates. In step S909 the CPU 302 stores in the HDD 305 the firmware version, for the multifunction peripheral itself, corresponding to the setting value specification management DB 410 sent to the setting value management server 110, and processing terminates.

As explained above, according to the present embodiment, the present invention provides a system that includes the plurality of multifunction peripherals 120a,b, and the setting value management server 110 that manages in consolidation information regarding a setting value for the plurality of multifunction peripherals 120a,b. More specifically, when accessing the setting value management server 110 for the first time, the multifunction peripherals 120a,b query the setting value management server 110 as to whether it is necessary to transmit information relating to the setting value for each multifunction peripheral to the setting value management server 110. In response to the query, the setting value management server 110 responds by determining that transmission is necessary if the setting value management server 110 does not hold information relating to the setting value for the multifunction peripheral. Thereby, from the start the setting value management server 110 does not need to manage information relating to the setting value for all apparatuses included in the network, it is possible to manage the information as necessary, and usage as a server is possible even if storage capacity is not very large.

### Second Embodiment

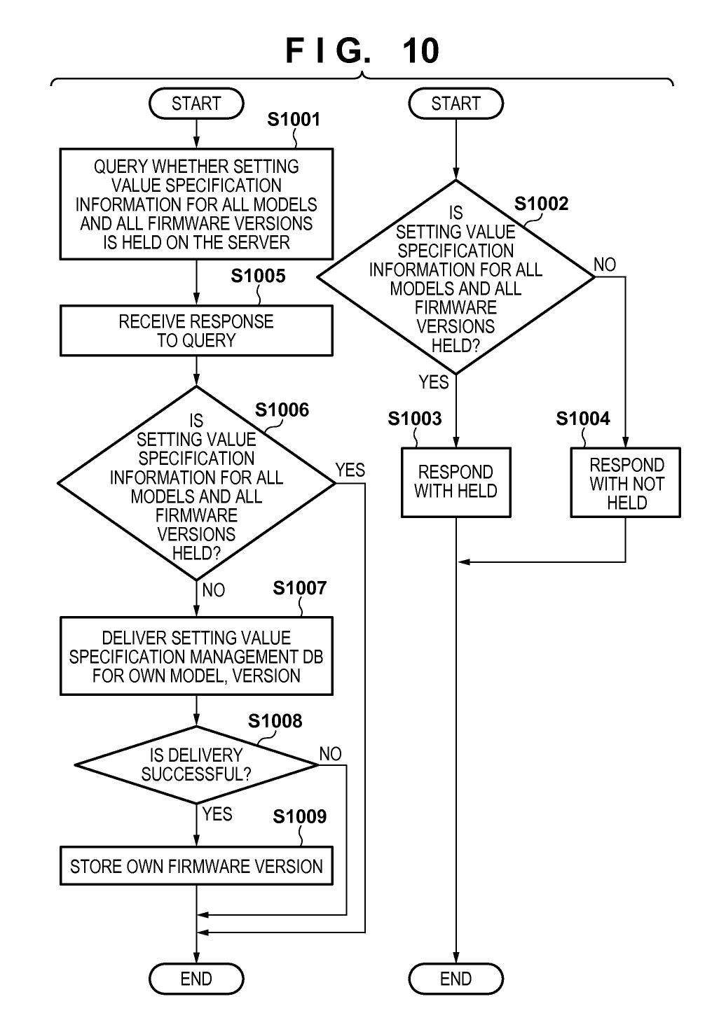

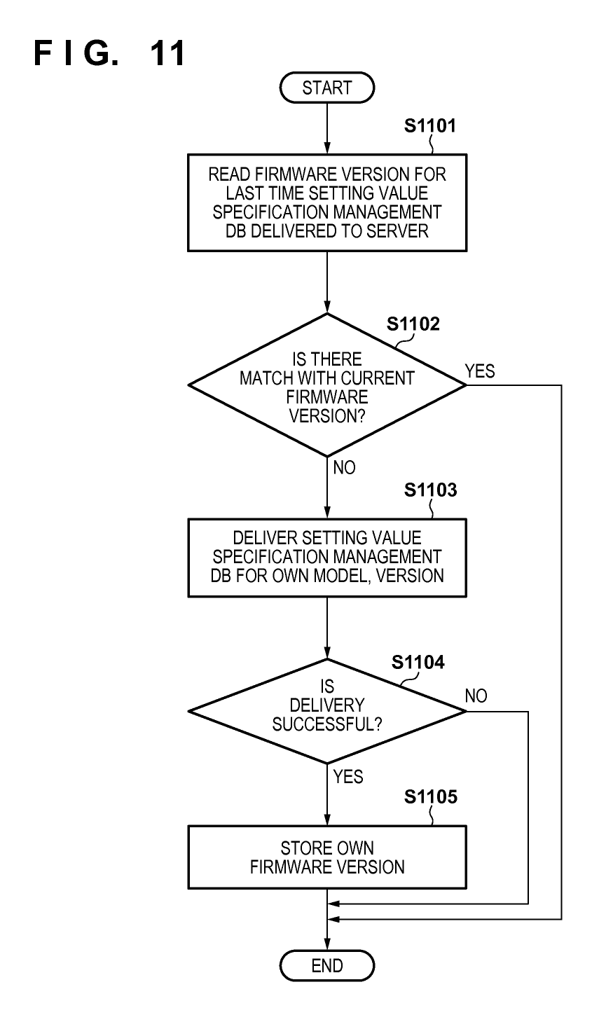

Below, explanation will be given for a second embodiment of the present invention with reference to FIG. 10. The above-described first embodiment explained control to query as to whether there is a need to send the setting value specification management DB 410 to the setting value management server 110 when the multifunction peripherals 120a,b initially connect to the setting value management server 110. In the present embodiment, control of whether to send the setting value specification management DB 410 depends on whether a counterparty is a dedicated server. In a configuration of preparing a dedicated server as the setting value management server 110, the setting value specification management DB 410 for all models and all firmware versions is held in advance in the setting value management server 110. Accordingly, in the case of a dedicated server, it is possible to determine that there is no necessity to send the setting value specification management DB 410. In contrast, in a configuration of using a multifunction peripheral as a server, it is difficult to hold in advance the setting value specification management DB 410 for all models and firmware versions on the server, because the storage capacity is not very large, or the like. Accordingly, it is possible to determine that sending is necessary. In the present embodiment, configuration is taken so that the multifunction peripherals 120a,b first query the setting value management server 110 as to whether the setting value specification management DB 410 for all models and all firmware versions is held, and then send the setting value specification management DB 410 only in the case of not holding.

FIG. 10 indicates a processing procedure for sending the setting value specification management DB 410 when the multifunction peripherals 120a,b perform an initial connection to the setting value management server 110. This flowchart is executed by the CPU 203 of the setting value management server 110 and the CPU 302 of the multifunction peripherals 120a,b reading a program from the HDD 205 and the HDD 305, loading the program into the RAM 204 and the RAM 303, and then executing the program. Note that step S1001, step S1005 or later indicates processing in the multifunction peripherals 120a,b, and step S1002 to step S1004 indicates processing in the setting value management server 110. In the following explanation, explanation for portions that overlap with the above-described first embodiment is omitted. Here, step S1005 is the same as step S905, step S1007 is the same as step S907, step S1008 is the same as step S908 and step S1009 is the same as step S909, so explanation thereof is omitted.

In step S1001, the CPU 302 queries the setting value management server 110 as to whether the setting value specification management DB 410 for all models and all firmware versions is held on the server. Here, the case in which one setting value specification management DB 410 holds specification information for all models and all firmware versions is deemed to be the same as described above.

In step S1002, the CPU 203 determines whether the setting value specification management DB 410 for all models and all firmware versions is held on the server, in response to the query of step S1001. If held, the processing proceeds to step S1003, if not held, the processing proceeds to step S1004. In step S1003, the CPU 203 responds to the multifunction peripherals 120a,b that the setting value specification management DB 410 for all models and all firmware versions is held on the server and processing terminates. Meanwhile, in step S1004, the CPU 203 responds that the setting value specification management DB 410 for all models and all firmware versions is not held on the server, to the multifunction peripherals 120a,b, and processing terminates.

In step S1006, the CPU 302 determines whether the response received in step S1005 indicates that the setting value specification management DB 410 for all models and all firmware versions is held on the server. If not held, the processing proceeds to step S1007, if held processing terminates.

As explained above, according to the present embodiment, the multifunction peripheral queries the server on whether the setting value specification management DB 410 for all models and all firmware versions is held on the server. Thereby, it is possible to send the setting value specification management DB 410 only in the case in which the setting value specification management DB 410 for all models and all firmware versions is not held on the setting value management server 110.

### Third Embodiment

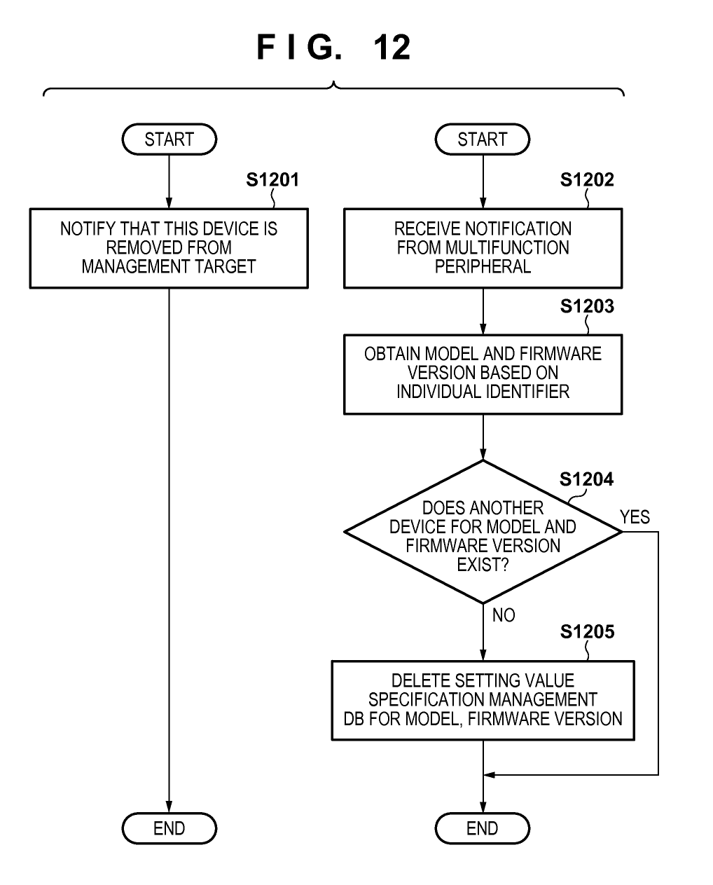

Below, explanation will be given for a third embodiment of the present invention with reference to FIG. 11. In the above-described first embodiment, explanation was given of processing to send the setting value specification management DB 410, when the multifunction peripherals 120a,b initially connect to the setting value management server 110. In the present embodiment, explanation is given for a case in which a change of a setting value occurs other than the cases described above. More specifically, in the present embodiment, explanation is given of a case of, when executing an update or version downgrade for the firmware of the multifunction peripherals 120a,b, accordingly generating a change in the setting value specification management DB 410 and sending the setting value to the setting value management server 110. Note that it is possible to apply a configuration specific to the present embodiment in combination with an above-described configuration of the first or second embodiment.

FIG. 11 indicates a processing procedure for sending the setting value specification management DB 410 to the setting value management server 110 when an update or version downgrade occurs for the firmware of the multifunction peripherals 120a,b, that is when the version of the firmware changes. This flowchart is something for which the CPU 302 of the multifunction peripherals 120a,b reads a program from the HDD 305, loads the program into the RAM 303, and then executes the program. In the following explanation, explanation for portions that overlap with the above-described first embodiment is omitted. Here, step S1103 is the same as step S907, step S1104 is the same as step S908, step S1105 is the same as step S909, and explanation thereof is omitted.

In step S1101, if the version of the firmware changes, the CPU 302 reads the version of the firmware for the previous time when the setting value specification management DB 410, which is saved on the HDD 305, was sent to the setting value management server 110. Subsequently, in step S1102 the CPU 302 determines whether the version of the firmware obtained in step S1101 matches the current version of the firmware itself by comparing. Based on the result of the comparison, the processing proceeds to step S1103 in a case of not matching, and processing terminates in a case of matching.

As explained above, according to the present embodiment, whether to send the setting value specification management DB 410 is determined based on whether the version of the multifunction peripheral firmware for the previous time the setting value specification management DB 410 was sent to the setting value management server 110 matches the current version. In other words, in the present embodiment, because a change to the setting value specification management DB 410 is only reflected when an update or version downgrade of the firmware is performed, the latest DB is sent to the setting value management server 110. Accordingly, in sending of the setting value specification management DB 410, it is possible to avoid wasteful sending.

### Fourth Embodiment

Below, explanation will be given for a fourth embodiment of the present invention with reference to FIG. 12. When a predetermined multifunction peripheral is removed from a management target of the setting value management server 110, if the setting value specification management DB 410 sent from the multifunction peripheral is not deleted, unnecessary data remains on the server, and the storage capacity is pressed. In the present embodiment, explanation is given for control of a setting value specification management DB transmitted from a multifunction peripheral that is to be removed from a management target. Note that it is possible to apply a configuration specific to the present embodiment in combination with an above-described configuration of the first through third embodiments.

FIG. 12 illustrates a processing procedure between the setting value management server 110 and a multifunction peripheral when the multifunction peripheral is to be removed from a management target of the setting value management server 110. Explanation is given below of a case in which the multifunction peripheral 120a is removed from a management target of the setting value management server 110. This flowchart is executed by the CPU 203 of the setting value management server 110 and the CPU 302 of the multifunction peripheral 120a reading a program from the HDD 205 and the HDD 305, loading the program into the RAM 204 and the RAM 303, and then executing the program. Note that step S1201 is processing in the multifunction peripheral 120a, and step S1202 onward is processing in the setting value management server 110.

In step S1201, the CPU 302 notifies the setting value management server 110 that the multifunction peripheral 120a is to be removed from a management target. Here, the device identifier for multifunction peripheral 120a is also communicated.

In step S1202, the CPU 203 receives the notification sent from the multifunction peripheral 120a in step S1201. In step S1203, the CPU 203 refers to the device configuration information management DB 412, and obtains a model and a firmware version based on the device identifier communicated in step S1201. In step S1204, the CPU 203 refers to the device configuration information management DB 412 and the registered device management DB 413, and determines whether another device for the model and firmware version obtained in step S1203 exists. If another device for the model and firmware version obtained in step S1203 does not exist, the processing proceeds to step S1205, another device for the model and firmware version obtained in step S1203 exists, the processing terminates. In step S1205 the CPU 203 deletes the setting value specification management DB 410 corresponding to the model and firmware version obtained in step S1203 from the memory region of the setting value management server 110.

As explained above, according to the present embodiment, when the multifunction peripheral 120a is removed from the management target of the setting value management server 110, the setting value specification management DB 410 is deleted as necessary. Thereby, it is possible to delete wasteful data from the server, and prevent pressure on the storage capacity.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-167000 filed on Aug. 19, 2014, which is hereby incorporated by reference herein in its entirety.

What is claimed is:

1. A system comprising an image processing apparatus and a server managing the image processing apparatus, wherein
the image processing apparatus comprises:
a storage unit configured to store a setting value for defining operation content of the image processing apparatus; and
a transmission unit configured to transmit to the server specification management information that includes information that indicates a range for a value that can be set in the setting value;
and the server comprises:
a management unit configured to manage master data for the setting value;
a reception unit configured to receive the specification management information transmitted by the transmission unit;
a change unit configured to change the master data managed by the management unit based on the specification management information received by the reception unit; and
a first notification unit configured to communicate to the image processing apparatus information relating to a change to the master data by the change unit,
wherein the image processing apparatus is configured to update the setting value stored by the storage unit based on the information communicated by the first notification unit.

2. The system according to claim 1, wherein the image processing apparatus
further comprises a second notification unit configured to communicate to the server information relating to a change of the setting value when the setting value stored by the storage unit is changed, and
the server is configured to update the master data managed by the management unit based on the information communicated by the second notification unit.

3. The system according to claim 1, wherein the system comprises a plurality of the image processing apparatuses, and the server manages the plurality of the image processing apparatuses,
the first notification unit communicates to the plurality of the image processing apparatuses information relating to the change to the master data by the change unit, and
the setting value of each of the plurality of the image processing apparatuses is updated based on the information communicated by the first notification unit.

4. The system according to claim 1, wherein the transmission unit transmits the specification management information when first accessing the server.

5. The system according to claim 1, further comprising a querying unit configured to query the server as to whether transmitting the specification management information is necessary, wherein
the transmission unit transmits the specification management information in accordance with a response to the query.

6. The system according to claim 5, wherein the querying unit is configured to transmit a model name and a firmware version for the image processing apparatus to the server when querying the server.

7. The system according to claim 1, wherein the transmission unit is configured to transmit specification management information relating to a model and a firmware version for the image processing apparatus in a case where the server does not hold the specification management information.

8. The system according to claim 1, further comprising a determination unit configured to determine, whether the server holds the specification management information relating to the setting value for all of a plurality of the image processing apparatuses that are synchronizing the setting value via the server,
wherein the transmission unit is configured to control whether to transmit the specification management information to the server in accordance with a result of the determination by the determination unit.

9. The system according to claim 1, wherein the transmission unit is configured to transmit the specification management information when a firmware version of the image processing apparatus is changed.

10. The system according to claim 1, wherein the setting value comprises at least one of a density correction for a color material, a toner amount correction at a time of printing, an auto-sleep transition time, or a display of a job history.

11. The system according to claim 1, wherein the specification management information comprises at least one of a key identifier for identifying a setting value, an initial value of a setting value, or a display condition for a setting value.

12. An image processing apparatus, comprising:
a storage unit configured to store a setting value for defining operation content of the image processing apparatus;
a transmission unit configured to transmit specification management information that comprises information that indicates a range for a value that can be set in the setting value to a server that manages master data for the setting value;
a reception unit configured to receive information related to a change to the master data, which is communicated from the server in accordance with a change to the master data based on the specification management information transmitted by the transmission unit; and
an updating unit configured to update the setting value stored by the storage unit based on the information received by the reception unit.

13. The image processing apparatus according to claim 12, wherein the transmission unit is configured to transmit the specification management information when a firmware version of the image processing apparatus is changed.

14. The image processing apparatus according to claim 12, wherein the setting value comprises at least one of a density correction for a color material, a toner amount correction at a time of printing, an auto-sleep transition time, or a display of a job history.

15. The image processing apparatus according to claim 12, wherein the specification management information comprises at least one of a key identifier for identifying a setting value, an initial value of a setting value, or a display condition for a setting value.

16. A server configured to manage an image processing apparatus, comprising:
a management unit configured to manage master data for a setting value for defining operation content of the image processing apparatus;
a reception unit configured to receive specification management information, transmitted from the image processing apparatus, comprising information indicating a range for a value that can be set in the setting value;
a change unit configured to change the master data managed by the management unit based on the specification management information received by the reception unit; and
a notification unit configured to communicate to the image processing apparatus information relating to a change to the master data by the change unit.

17. The server according to claim 16, wherein the setting value comprises at least one of a density correction for a color material, a toner amount correction at a time of printing, an auto-sleep transition time, or a display of a job history.

18. The server according to claim 16, wherein the specification management information comprises at least one of a key identifier for identifying a setting value, an initial value of a setting value, or a display condition for a setting value.

19. A method of a system comprising an image processing apparatus and a server managing the image processing apparatus, the method comprising:
the image processing apparatus
storing a setting value for defining operation content of the image processing apparatus in a storage unit; and
transmitting to the server specification management information that comprises information that indicates a range for a value that can be set in the setting value,
and the server
managing master data for the setting value;
receiving the transmitted specification management information;
changing the managed master data based on the received specification management information; and
first communicating to the image processing apparatus information relating to a change to the master data in the change step,
wherein the image processing apparatus is configured to update the setting value stored in the storage unit based on the information first communicated.

20. A method of controlling an image processing apparatus, the method comprising:
storing a setting value for defining operation content of the image processing apparatus in a storage unit; and
transmitting specification management information that comprises information that indicates a range for a value that can be set in the setting value to a server that manages master data for the setting value;
receiving information related to a change to the master data, which is communicated from the server in accordance with a change to the master data based on the transmitted specification management information; and
updating the setting value stored in the storage unit based on the received information.

21. A method of a server configured to manage an image processing apparatus, the method comprising:
managing master data for a setting value for defining operation content of the image processing apparatus;
receiving specification management information, transmitted from the image processing apparatus, comprising information indicating a range for a value that can be set in the setting value;
changing the managed master data based on the received specification management information; and
communicating to the image processing apparatus information relating to the changing of the master data.
